(19) United States
(12) Patent Application Publication
(10) Pub. No.: US 2009/0194036 A1
(43) Pub. Date: Aug. 6, 2009

(54) Tartar control dog treat

(75) Inventor: Meng-Husan Lou, Jiashan (CN)

Correspondence Address: BACON & THOMAS, PLLC, 625 SLATERS LANE, FOURTH FLOOR, ALEXANDRIA, VA, 22314-1176, US

(73) Assignee: JIASHAN CONWELL INDUSTRIAL CO., LTD., Jiashan (CN)

(21) Appl. No.: 12/010,910

(22) Filed: Jan. 31, 2008

(51) Int. Cl. A01K 29/00

(52) U.S. Cl. 119/709

(57) ABSTRACT

A tartar control dog treat includes a body with a convex surface and a concave surface complementary and immediately adjacent to the convex surface. The body is composed of two secondary bodies each having a flange formed on an outer peripheral edge of the respective secondary body. Combining holes are defined in each of the flanges so that after a strip is extended through the aligned combining holes, the engagement between the two secondary bodies is secured.

### BACKGROUND OF THE INVENTION

1. Field of the Invention

The present invention relates to a kind of dog treats, and more particularly to a tartar control dog treat so as to provide a user friendly and long lasting chewing period of time.

2. Description of the Prior Art

In the market, there are all kinds of dog treats to provide a long lasting chewing period of time for the dogs. Most of the dog treats provide tartar control effect to the dogs so that when the dogs are chewing the dog treats (bones), dog teeth can be cleaned. Some may also have additives, such that the dogs are attracted to chew the bones. No matter how many different brands or what kind of material the dog treats are made of, the dog treats can generally divided into the following categories:
1. The dog treat is made of plastic. However, because once the product is swallowed by dogs, the dogs might be killed by the plastic or even substances inside the plastic, which results in that this kind of product occupies only a small portion of the market share.
2. The dog treat is made of edible material so that after the dog chews the bone, fragment of the bone may be swallowed without hurting the dog. Because this edible substance is harmless to the dogs, this kind of dog treat occupies a large market share.

In order to provide better teeth cleaning effect, a kind of dog treat made of cowhide is introduced to the market. Although this product is solid and durable under repetitive chewing of dogs, it does not taste good and quickly the dogs lost interest chewing the bones. More over, this type of product is not suitable for small-sized dogs.

To obviate the drawbacks, a different dog treat is introduced to the market and made of strip-liked cowhide curved to form a bone. This product has two knots tied at two distal ends of the bone so that when the dog is chewing the product, the dog's two front pawls generally lay down on one of the two knots and bites the other to progress the chewing by extending the bone. After a period of time the bone soaking in the saliva, the bone extends. However, after the bone extends to a certain extent where there is no elasticity left in the bone, the dog lost interest in the bone. A still further product having a sheet like shape is introduced to the market, with which, the dog chews and bites the product and has no way to extend the bone such that the problem of having no elasticity left in the bone is solved. But, still the problem of being difficult for the dogs to chew or bite on may be the primary issue to be solved for this sheet-like product. Especially, most of the current available products have smooth surfaces, which degrades the effect to clean the dog teeth.

### SUMMARY OF THE INVENTION

In order to entirely obviate the aforementioned problems, the present invention provides a tartar control dog treat having a body provided with a concave surface, a convex surface complementary and immediately adjacent to the concave surface and a flange surrounding an outer peripheral edge of the body such that the concave surface together with the convex surface enables the dog to easily chew on the body.

A further objective of the present invention is that the body has combining holes defined in the flange so that two bodies may be combined to form a hollow combination. Inside the hollow combination, objects having great scent to the dogs are stored. Thus the dogs are attracted to chew on the body of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top plan view of the dog treat of the present invention;

FIG. 2 is a cross sectional view of FIG. 1 taking the line 2-2;

FIG. 3 is a cross sectional view of FIG. 1 taking the line 3-3;

FIG. 4 is a top plan view of a second embodiment of the dog treat of the present invention;

FIG. 5 is a cross sectional view of FIG. 4 taking the line 5-5;

FIG. 6 is a top plan view of the third embodiment of the dog treat of the present invention;

FIG. 7 is a cross sectional view of FIG. 6 taking the line 7-7;

FIG. 8 is a side plan view of the fourth embodiment of the present invention; and

FIG. 9 is a cross sectional view of FIG. 8 taking the line 9-9.

### DETAILED DESCRIPTION OF THE PREFERRED EMBODIMENT

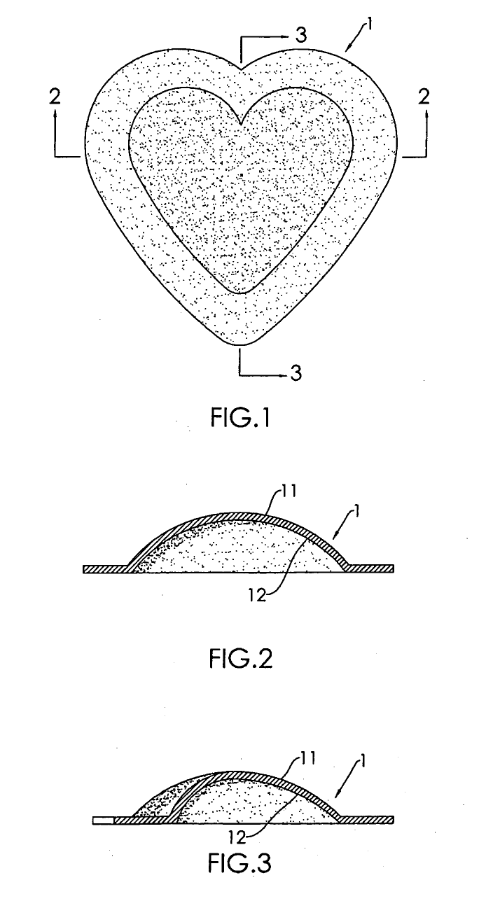

With reference to FIGS. 1, 2 and 3, it is to be noted that the dog treat constructed in accordance with the present invention is formed into a heart shape and has a body 1, a convex surface 11 formed on a central portion of the body 1 and a concave surface 12 complementary and immediately adjacent to the convex surface 11. The body 1 is made by injection molding.

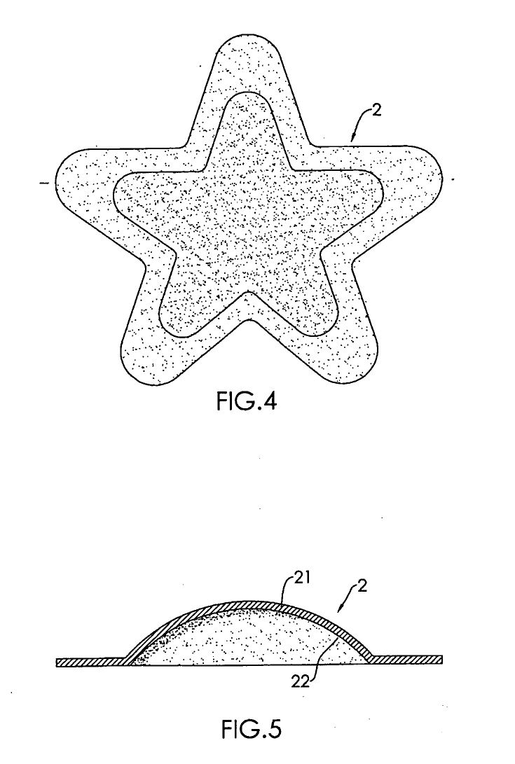

With reference to FIGS. 4 and 5, the second embodiment of the dog treat of the present invention is now formed into a star shape and still has a body 2, a convex surface 21 formed on a central portion of the body 2 and a concave surface 22 complementary and immediately adjacent to the convex surface 21.

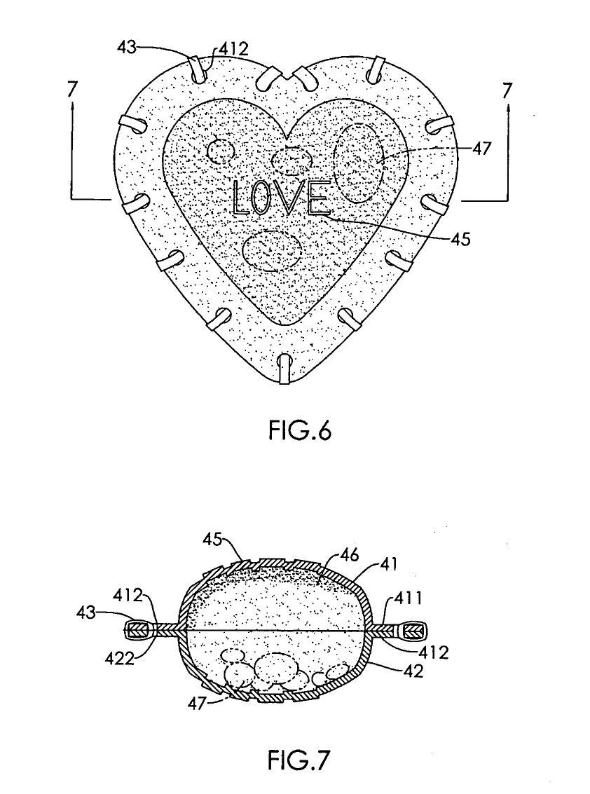

With reference to FIGS. 6 and 7, the third embodiment of the present invention shows that the dog treat is a combination of two bodies 41, 42 each having a convex surface formed on a central portion of the body and a concave surface complementary and immediately adjacent to the convex surface. The dog treat in this embodiment has a heart shape and each body 41, 42 has a flange 411, 421 surrounding a peripheral edge of the bodies 41, 42 respectively. Each of the flanges 411, 421 has combining holes 412, 422 defined in the respective flange 411, 421. The combining holes 412 are aligned with the combining holes 422 so that a strip 43 may extend through the aligned combining holes 412, 422 to secure the engagement between two bodies 41, 42. Furthermore, a pattern 45 may be formed on the convex surface of each of the bodies 41, 42 and additives 47 such as food or biscuit may be stored in a space 46 defined by the combination of the two bodies 41, 42. It is noted that in the first embodiment and the second embodiment, each of the bodies 1, 2 has a flange formed on an outer periphery of the respective body 1, 2.

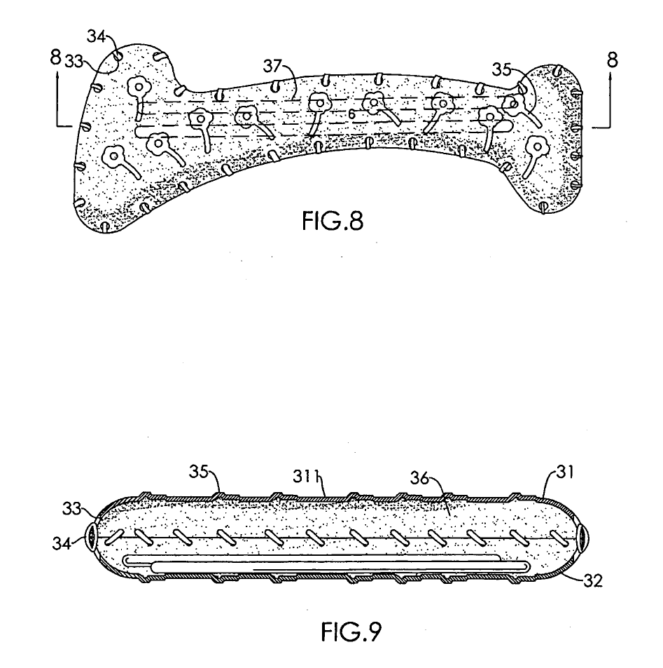

With reference to FIGS. 8 and 9, it is noted that the dog treat of the present invention has two bodies 31, 32 respectively having a convex surface 311 formed on a central portion of the body 31, 32 and a concave surface 312 (reference numerals 311, 312 are only designated to the upper body 31, but this is not a limitation to the fact that the lower body 32 is now provided with the convex surface and the concave surface). The two bodies 31, 32 are combined to form a space 36 therebetween and a pattern 35 is formed on an outer surface of the convex surface 311. Combining holes 33 are defined through a respective flange of each of the two bodies 31, 32 such that a strip 34 is able to extend through the aligned combining holes 33 to secure the engagement between the two bodies 31, 32.

From the above embodiments of the present invention, it is to be noted that due to the convex and concave surfaces as well as the pattern on the convex surface of the embodiments, the coarse effect of the dog treat of the present invention increases friction to the dog's teeth such that the cleaning purpose to the dog's teeth is accomplished. In addition, the additives may be different according to the dog's preference and the strip and the body may be made of such as cowhide or edible material so that there will be no harm to the users (dogs).

Those skilled in the art will readily observe that numerous modifications and alterations of the device and method may be made while retaining the teachings of the invention.

What is claimed is:

1. A dog treat comprising:
a body with a convex surface formed on a central portion of the body and a concave surface complementary and immediately adjacent to the convex surface.

2. The dog treat as claimed in claim 1, wherein the body further has a flange formed on an outer peripheral edge of the body.

3. The dog treat as claimed in claim 1, wherein the body has a heart shape.

4. The dog treat as claimed in claim 1, wherein the body has a star shape.

5. The dog treat as claimed in claim 1, wherein the body is composed of two secondary bodies securely engaged with each other and a space is defined between the two secondary bodies for receiving additives.

6. The dog treat as claimed in claim 5, wherein each of the two secondary bodies has a flange formed on an outer peripheral edge of the secondary body and provided with combining holes aligned with one another so that a strip is able to extend through the combining holes of the two secondary bodies to secure the engagement of the two secondary bodies.

7. The dog treat as claimed in claim 5, wherein a pattern is formed on an outer surface of the convex surface.

8. The dog treat as claimed in claim 6, wherein a pattern is formed on the convex surface.

9. The dog treat as claimed in claim 5, wherein each of the two secondary bodies has combining holes defined in an outer periphery thereof and aligned with one another so that a strip is able to extend through the combining holes of the two secondary bodies to secure the engagement of the two secondary bodies.
